(19) United States
(12) Patent Application Publication
(10) Pub. No.: US 2012/0158490 A1
(43) Pub. Date: Jun. 21, 2012

(54) SPONSORED SEARCH AUCTION MECHANISM FOR RICH MEDIA ADVERTISING

(75) Inventors: Leonardo Neumeyer, Palo Alto, CA (US); Michael Schwarz, Berkeley, CA (US); Sharath Rao, Fremont, CA (US)

(73) Assignee: Yahoo! Inc., Sunnyvale, CA (US)

(21) Appl. No.: 12/970,586

(22) Filed: Dec. 16, 2010

(51) Int. Cl. G06Q 30/00

(52) U.S. Cl. 705/14.46

(57) ABSTRACT

A system for selecting a rich advertisement for display to a user is provided. The system may include an advertisement engine with a first selection module configured to select a list of text advertisements for a text slate based on a query entered by the user and determine a first expected revenue of the text slate according to a first auction of text advertisements. The advertisement engine may also include a second selection module configured to select a rich advertisement for a mixed slate based on the query entered by the user and determine a second expected revenue of the mixed slate. Further, the advertisement engine may determine whether to display the text slate or the mixed slate based on the first expected revenue and the second expected revenue.

### BACKGROUND

### 1. Field of the Invention

The present invention generally relates to a method and system for implementing sponsored search.

### SUMMARY

A system for selecting a rich advertisement for display to a user is provided. The system may include an advertisement engine with a first selection module configured to select a list of text advertisements for a text slate based on a query entered by the user and determine a first expected revenue of the text slate according to a first auction of text advertisements. The advertisement engine may also include a second selection module configured to select a rich advertisement for a mixed slate (e.g. both rich and text advertisements) based on the query entered by the user and determine a second expected revenue of the mixed slate. Further, the advertisement engine may determine whether to display the text slate or the mixed slate based on the first expected revenue and the second expected revenue.

Further features of this application will become readily apparent to persons skilled in the art after a review of the following description, with reference to the drawings and claims that are appended to and form a part of this specification.

### BRIEF DESCRIPTION OF THE DRAWINGS

The drawings described herein are for illustration purposes only and are not intended to limit the scope of the present disclosure in any way.

FIG. 1 is a system for a sponsored search auction;

FIG. 2 is a web page illustrating a sponsored search;

FIG. 3 is one example of a rich ad for sponsored search;

FIG. 4 is an illustration of a web page including a rich ad;

FIG. 5 is a flow chart illustrating a process for a sponsored search auction for a rich ad;

FIG. 6 is a graph illustrating the estimated opportunity cost compared to the actual revenue for a set of queries;

FIG. 7 is a bar graph illustrating the query click through rate by query group;

FIG. 8 is a bar graph illustrating the RPDS by query group;

FIG. 9 is a bar graph illustrating the impact of rich ads in sponsored search on the SERP click share; and

FIG. 10 is an exemplary computer system for use in a sponsored search auction system.

It should be understood that throughout the drawings, corresponding reference numerals indicate like or corresponding parts and features.

### DETAILED DESCRIPTION

The sponsored search marketplace is rapidly changing with the arrival of new ad formats containing richer media such as additional links, video and images. Since these disparate ad types have to compete for limited real-estate on the Search Results Page (SERP), it may be beneficial that the allocation and pricing of ads be done in a principled manner. A method to integrate two different types of sponsored lists on the SERP is provided herein—namely the existing text ads and the recently introduced Rich Ads in Search (RAIS). Results from live-traffic are presented herein that show users are attracted to quality rich content on the SERP as evidenced from the 55% increase in page click-through rate (CTR). Moreover, the 28% increase in page revenue indicates that rich content with exclusive and prominent placement can sustainably generate incremental revenue.

The search experience can be improved by enhancing web document results with richer presentation. Examples on search.yahoo.com include Search Monkey results with thumbnail images (e.g. Wikipedia results), user enabled applications that provide special treatment of a result (e.g. Yelp enhanced results), and expandable results with inline video content player. The success of these enhancements demonstrates that users take well to useful and relevant content regardless of whether that content includes plain links or richer media like images or video.

Rich Ads in Sponsored Search (RAIS) is an extension of the above idea into the Sponsored Search marketplace. RAIS ads augment the existing text ad with attributes such as additional links, video and images. However, given that the SERP has limited real-estate, RAIS ads can compete with text ads in an integrated marketplace. Integration of the market places gives rise to challenges such as allocation of scarce impressions, pricing of ads, ensuring the long-term health of the integrated marketplace by limiting advertiser/user attrition and continued revenue stream for Yahoo. The design of a marketplace and an analysis of the performance of RAIS ads is provide herein. One specific aspect of a RAIS ad may be an exclusive north (above organic web results) placement. An exclusive north placement refers to the scenario where only one advertisement is placed at the top of the web page above the search results. The exclusive nature of an exclusive north placement requires changes to the conventional generalized second price (GSP) model of allocation and pricing. A broad range of technical problems and solutions are highlighted. For example, traffic shaping solution of reserving a share of impressions for text ads with a view to diversify revenue streams and incentivize advertisers to continue bidding on Yahoo. Also, subtle changes are proposed to how implicit (click) feedback from users can be handled in the presence of a new ad type.

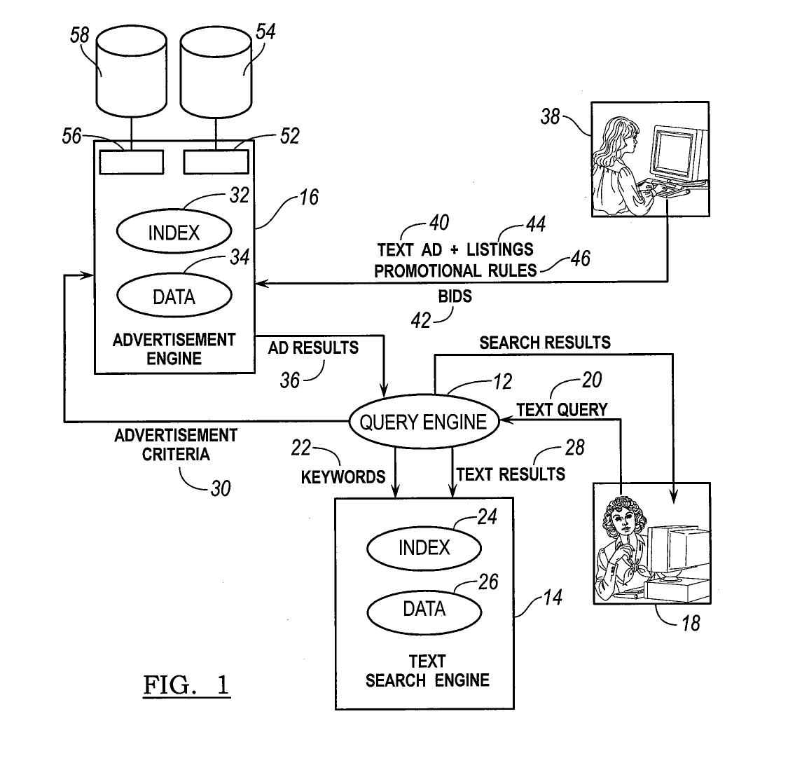

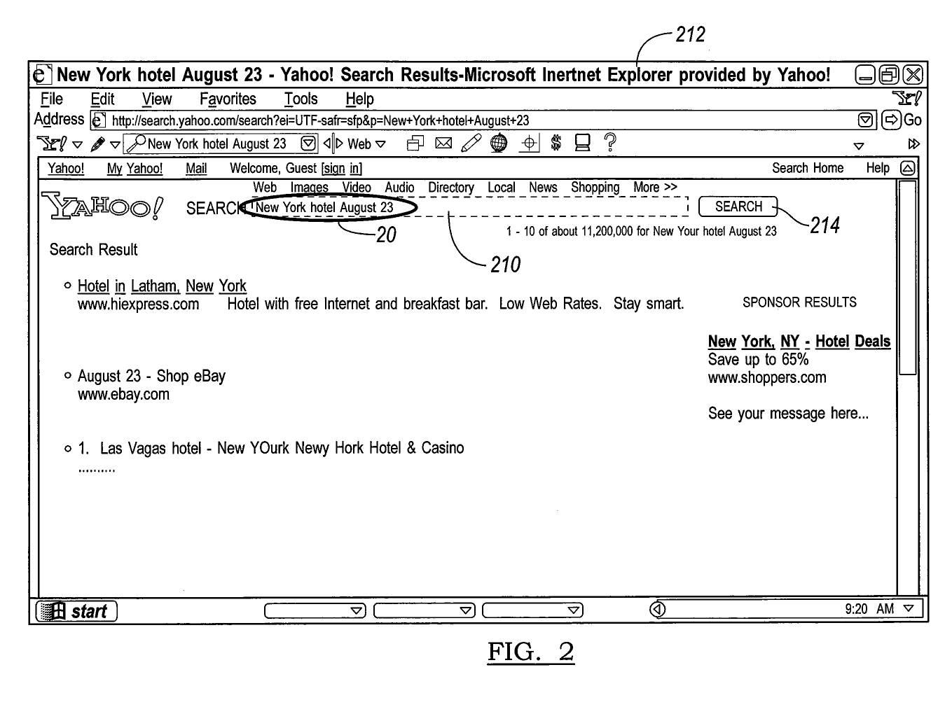

FIG. 1 shows a system 10, according to one embodiment, which includes a query engine 12 and an advertisement engine 16. The query engine 12 is in communication with a user system 18 over a network connection, for example over an Internet connection. In the case of a web search page, the query engine 12 is configured to receive a text query 20 to initiate a web page search. The text query 20 may be a simple text string including one or more keywords that identify the subject matter for which the user wishes to search. For example, the text query 20 may be entered into a text box 210 located at the top of the web page 212, as shown in FIG. 2. In the example shown, five keywords “New York hotel August 23” have been entered into the text box 210 and together form the text query 20. In addition, a search button 214 may be provided. Upon selection of the search button 214, the text query 20 may be sent from the user system 18 to the query engine 12. The text query 20 also referred to as a raw user query, may be simply a list of terms known as keywords.

The query engine 12 provides the text query 20, to the text search engine 14 as denoted by line 22. The text search engine 14 includes an index module 24 and the data module 26. The text search engine 14 compares the keywords 22 to information in the index module 24 to determine the correlation of each index entry relative to the keywords 22 provided from the query engine 12. The text search engine 14 then generates text search results by ordering the index entries into a list from the highest correlating entries to the lowest correlating entries. The text search engine 14 may then access data entries from the data module 26 that correspond to each index entry in the list. Accordingly, the text search engine 14 may generate text search results 28 by merging the corresponding data entries with a list of index entries. The text search results 28 are then provided to the query engine 12 to be formatted and displayed to the user.

The query engine 12 is also in communication with the advertisement engine 16 allowing the query engine 12 to tightly integrate advertisements with the content of the page and, more specifically, the user query and search results in the case of a web search page. To more effectively select appropriate advertisements that match the user's interest and query intent, the query engine 12 is configured to further analyze the text query 20 and generate a more sophisticated set of advertisement criteria 30. The query intent may be better categorized by defining a number of domains that model typical search scenarios. Typical scenarios may include looking for a hotel room, searching for a plane flight, shopping for a product, or similar scenarios. Alternatively, if the web page is not a web search page, the page content may be analyzed to determine the user's interest to generate the advertisement criteria 30.

The advertisement criteria 30 is provided to the advertisement engine 16. The advertisement engine 16 includes an index module 32 and a data module 34. The advertisement engine 16 performs an ad matching algorithm to identify advertisements that match the user's interest and the query intent. The advertisement engine 16 compares the advertisement criteria 30 to information in the index module 32 to determine the correlation of each index entry relative to the advertisement criteria 30 provided from the query engine 12. The scoring of the index entries may be based on an ad matching algorithm that may consider the domain, keywords, and predicates of the advertisement criteria, as well as the bids and listings of the advertisement. The bids are requests from an advertiser to place an advertisement. These requests may typically be related domains, keywords, or a combination of domains and keywords. Each bid may have an associated bid price for each selected domain, keyword, or combination relating to the price the advertiser will pay to have the advertisement displayed. The advertisements may include text advertisements and rich advertisements. The text advertisements may be stored in a text advertisement database 54 and the rich advertisements may be stored in a rich advertisement database 58. The advertisement engine 16 may include a first selection module 52 that selects a slate of text advertisements from the text advertisement database 54 based on a query entered by the user and determine an expected revenue according to a first auction of text advertisements. The advertisement engine 16 may also include a second selection module 56 configured to select a rich advertisement based on the query entered by the user and determine an expected value of the rich advertisement. Further, the advertisement engine 16 may determine whether to display the slate of text advertisements or the rich advertisement based on the expected revenue of the slate of text advertisements and an expected value of the rich advertisement. A more detailed description of the processes performed by the advertisement engine and/or either of the first and second selection modules is discussed below.

An advertiser system 38 allows advertisers to edit ad text 40, bids 42, listings 44, and rules 46. The ad text 40 may include fields that incorporate, domain, general predicate, domain specific predicate, bid, listing or promotional rule information into the ad text. The advertisement engine 16 may then generate advertisement search results 36 by ordering the index entries into a list from the highest correlating entries to the lowest correlating entries. The advertisement engine 16 may then access data entries from the data module 34 that correspond to each index entry in the list from the index module 32. Accordingly, the advertisement engine 16 may generate advertisement results 36 by merging the corresponding data entries with a list of index entries. The advertisement results 36 are then provided to the query engine 12. The advertisement results 36 may be provided to the user system 18 for display to the user.

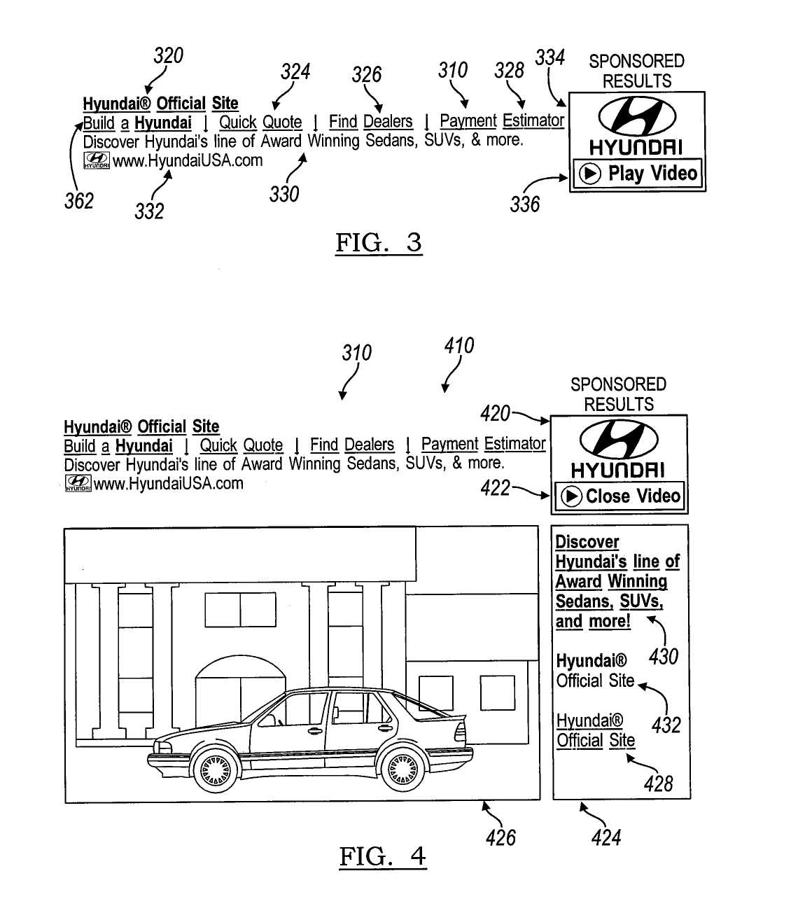

An example of a rich ad 310 is provided in FIG. 3. The format of the rich ad 310 may be representative of an exclusive north rich advertisement. The rich advertisement may include audio, video, links, widgets, or any combination of the above. The rich advertisement 310 may include a link to the advertisement site denoted by reference number 320. The rich advertisement may also include informational text as denoted by reference number 330. In one example, reference numeral 322 may refer to a link that leads to a page for building a vehicle or alternatively may allow access to a widget integrated into the advertisement that allows the user to build a vehicle. Similarly, reference numeral 324 may refer to a link that leads to a web page or a widget that allows the user to input certain basic parameters and receive a quote for a vehicle. Reference numeral 326 may refer to a link that leads to a web page or a widget for finding dealerships near the user or another inputted location. The web page or widget may use information stored with a user ID, IP information, or information stored in a cookie on the user system to determine the location. Reference numeral 328 may refer to a link that links to a web page or a widget that estimates the payment of a vehicle for a user. Additional other links may be provided as denoted by reference numeral 332. In addition, active elements such as denoted by reference numeral 344 may be provided such that as the user mouses over the active element 334, a video screen may be provided for the user to receive audio and/or video information related to the advertisement. In addition, a button 336 may be provided for the user to actuate the audio or video to be played.

Now referring to FIG. 4, a web page 410 is provided. The web page includes a rich advertisement 310 in the exclusive north position of the web page 410. Since the video is being played, the active element 344 may be grayed and shown as an inactive element 420. Further, a button 422 may be provided to stop the playing of the audio and video and close the video window 426. Various other ads and information may be provided in the east area 424 of the web page 410. In addition, links for other advertisements 428, 430 and additional informative text 432 may be provided along with the list of additional advertisement entries.

In addition to the attributes of a standard text ad—title, abstract and the URL—a RAIS advertisement may have a subtitle with widgets or deep links leading to various landing pages and a static thumbnail with an overlay calling the user to click to play a video message as shown in FIG. 4. Although the user may click on more than one of the 5 links or widgets, the advertiser may only pay for 1 click per ad. Note that even if the user clicks and views the video without visiting the landing page, it is may be considered a paid click. This payment model was designed to be simple to start with, even if not necessarily optimal. Another example template has two subtitle links and a submit box that might request a zip code and provide a car rental quote, for instance. Ideally, the ad itself can be dynamically composed from its attributes based on runtime context such as user features, query features etc. In the current implementation, a set of templates are defined and new templates can be created based on advertiser request.

A whitelist of keywords can be maintained and only keywords present in the list may qualify for RAIS bidding. In one example, only brand advertisers qualify to participate in the RAIS marketplace on queries containing their brand name. The brand advertiser however, may continue to bid on text ads for the same query in order to garner additional impressions when the RAIS ad may not be shown. For example, a keyword like “hyundai sonata 2010” may have a variety of advertisers including brand advertiser, auto dealers, auto financing companies etc. participating but only the brand advertiser may bid on a RAIS ad. Although this is one dominant use case for the system, other query segments where non-brand advertisers may participate in the RAIS marketplace may also be implemented.

The placement of a RAIS ad on the SERP can meet the following specifications:
1. RAIS ad meet minimum quality and revenue requirements.
2. If the RAIS ad is shown, it is ranked at the top position and placed above the web results.
3. No other ad appeal's between the RAIS ad and the web results e.g., the RAIS impression guarantees exclusive north placement thereby displacing text ads to the east (right extreme of the SERP).
4. If the RAIS ad is shown, then the corresponding text ad from the same advertiser is deduped.

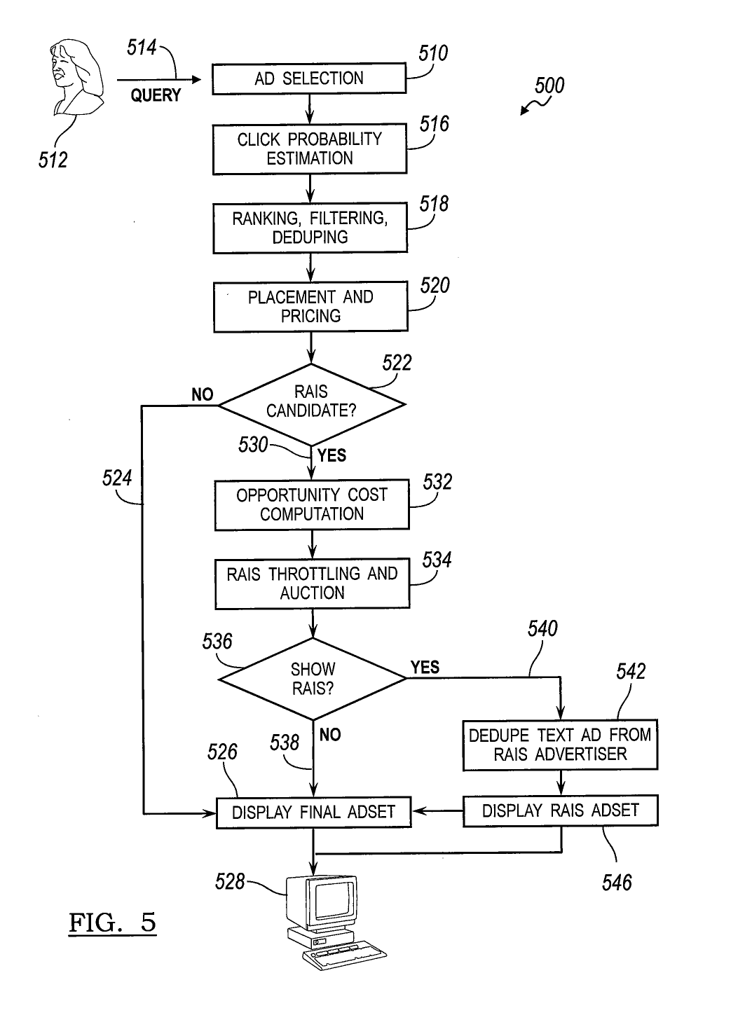

The RAIS marketplace must coexist with the conventional text ad marketplace on the SERP and, therefore, the optimizations such as trading off the component utilities of the stakeholders—users, advertiser and the auctioneer (who in case of Yahoo is also the publisher)—can be performed jointly. The steps involved in the Sponsored Search System that unifies the text marketplace and RAIS marketplace may be as follows:
1. Retrieve all ads from matching engines. If query is in the RAIS whitelist, this list includes the RAIS ad(s).
2. Compute the probability of click for each ad using the Standard Sponsored Search Click prediction model.
3. Execute the following stages of the text ad auction ranking, deduping, filtering, page placement and pricing.
4. With a coin toss constrained by the throttle rate, determine whether to throttle out RAIS ad. If so, go to step 9.
5. If more than one RAIS ad, conduct GSP auction within RAIS ads. Top ranked ad is a potential RAIS candidate.
6. Compute the opportunity cost of showing RAIS ad.
7 If RAIS quality and revenue requirements are met, decide to show RAIS ad. Price RAIS ad.
8. Dedupe corresponding text ad (if any) from RAIS advertiser. Move text ads to east to ensure exclusivity.
9. Display selected ads.
   This process is also illustrated in the flow chart provided in FIG. 5.

Now referring to FIG. 5, a method for selecting advertisements is provided. The method 500 begins with a user 512 providing a query 514 to the system. The system identifies a group of advertisements based on the query as denoted by block 510. The system then calculates the click probability for each ad on the list as denoted by block 516. The system then ranks, filters and dedupes the advertisements as denoted in block 518. The ranking may occur based on the click probability estimation as well as the bids for the advertisement. The filtering may occur based on predefined user preferences and how they match to the ad criteria and/or based on predefined advertiser preferences and how they match user criteria. Then deduping may occur to remove multiple advertisements by the same advertiser from showing up in a single list. Then the placement of the advertisement on the page and the pricing is determined as denoted by block 520. After the advertisement layout and pricing is determined, the system may determine if the current advertisement is a candidate for a rich advertisement for example, an exclusive north rich advertisement for a sponsored search. If the current advertisement is not a candidate, the method will follow line 524 to block 526 and the system will display the ad set in the format that was determined in block 520 to the user as denoted by reference numeral 528.

Referring again to block 522, if a candidate rich advertisement is available for that query, the method may follow line 530 to block 532. In block 532, the system calculates the opportunity cost for displaying a rich advertisement. In block 534, the rich advertisement throttling is evaluated and a rich advertisement auction is performed as denoted by reference number 534. If the rich advertisement is within the throttling parameters which may be predetermined for example, based on user criteria, category criteria, or other information, and the results of the auction provide a better revenue than the alternative placement and pricing model for example as denoted in block 520 then the system will determine whether to show the advertisement based on these factors as denoted by block 536. If the system determines to show the advertisement, the method follows line 540 to block 542 where the east and/or other advertisement spaces are deduped based on the winning rich advertisement advertiser such that for example, other advertisements from the winning rich advertiser are removed from the east area and any other advertisement areas on the web page. Then the method follows line 544 to block 546. The ad set including the rich advertisement, for example in the exclusive north position, is displayed in block 546 and provided to the user as denoted by reference numeral 528.

In the rest of this section, the details of one implementation of the allocation and pricing RAIS ads is described.

In a standard text-only auction, the ads are ranked by bid times click-through rate of the ad. In the Yahoo Sponsored Search system, in order to determine whether the ad appeal's in the north, a north utility score is computed for each ad and is compared against the north utility threshold. These thresholds are tuned to maintain a certain north footprint (average north ads per search). However, the RAIS ad may appear only in rank 1 and exclusively in the north. The opportunity cost of showing the RAIS ad is the potential revenue from the text ads that are now displaced to the east. Revenue considerations suggest that the RAIS ad be shown only when it generates at least as much revenue, on average, as the revenue from a text ad slate.

The first step in estimating the opportunity cost is to have a ranked list of text ads that would have been displayed if there were no RAIS ad. These ads are ranked, their north placement is determined, and they are priced as per the GSP. It is assumed that k such text ads are available at serve time of which N ads would have been shown in the north if there were no RAIS ad. The system computes the expected revenue ERₜₑₓₜ from the text ads as follows:

ERₜₑₓₜ=∝×Σₖ₌₁^{N}CTR(ad k,rank k)×PPC(ad k)) (1)

where PPC(k) is the price per click of ad k, CTR(ad k,rank k) is the click through rate of ad k at rank k of the text ad and alpha is the RAIS premium factor.

The CTR is predicted as the click-through rate of the ad for the current context. It is estimated by a machine learned model that takes into account the historical performance of the query-ad pair and broader context such as advertiser, user, etc. and syntactic features such as the degree of match between the content of the ad and the query. Equation (1) expresses the expected revenue over all ads that would have been shown in the north with an additional RAIS premium factor, ∝. The factor ∝ serves the purpose of correcting for error in estimating expected revenue. The production settings of ∝ may be set to 1.4. Also, the summation in equation (1) is over all K ads, including the K-N east ads. This accounts for a marginal premium over the opportunity cost estimate.

Having computed the expected revenue, the opportunity cost OC may be defined as follows:

OC=max(ERᵣₑₛₜ,minECPM) (2)

where minECPM is an absolute floor value. Both minECPM and ∝ raise the bar for showing the RAIS ad and hence help trade off quality and revenue for entire RAIS marketplace.

Although, in this example the performance of auctions is analyzed where only a single RAIS ad participates, the algorithm described below can easily accommodate multiple RAIS bidders. Since there is only one slot for the RAIS ad on the SERP, the allocation of the RAIS ad then becomes a two-pass process where the winner of the RAIS only auction is determined in the first pass. This auction is a standard second price auction with a single good (top slot) whose winner is the top ranked ad. In the second pass, the winner competes against the text ads to claim north exclusivity. (With a single RAIS ad, this reduces to the trivial action of picking the only RAIS ad). Having determined the RAIS ad that competes in the second pass, the second expected revenue of the RAIS ad contingent on exclusive north position is computed. Consider the RAIS ad r,

RV=CTR(ad r,rank 1)×bid(ad r) (3)

Given the estimated opportunity cost and the expected value from RAIS ad, the allocation rule is simple: show RAIS ad if the RV>=OC.

Pricing the RAIS ad follows from the GSP dictum that winner pays the minimum bid necessary to cause the outcome(s) of the auction. In this example, the RAIS ad causes 3 outcomes when it appears exclusively in the north:
1. It participates in the auction such that it pays at least the market reserve price PPCₘᵣₚ
2. It displaces text ads to the east such that it pays the minimum necessary to meet the opportunity cost PPCₒₑ. From (2) we have,

CTR(ad r,rank 1)×bid(ad r)>OC (4)
Since PPCₒₑ is the minimum necessary to meet the above criterion, we have

PPCₒₑ=OC/CTR(ad r,rank 1) (5)
3. The RAIS ad pays the minimum necessary to maintain the first rank among all competing RAIS ads. By GSP criteria:

$${PPC}_{withinrais} = \frac{bid ( 2 ) \times CTR ( 2 )}{CTR ( 1 )} \qquad ( 6 )$$

where CTR(1) and CTR(2) are the rank normalized CTRs of the RAIS ad at respective ranks and bid(2) is the bid of the losing RAIS ad.
Since each of the 3 outcomes may be required to occur in this example of the process, the RAIS ad pays the maximum of the above prices. PPCᵣₐᵢₛ

PPCᵣₐᵢₛ=max(PPCₘᵣₚ,PPCₒₑ,PPC_{withinrais}) (7)

A share of potential SERP impressions (for example, predetermined percentage) for each RAIS eligible query is reserved for text ad SERPs only. Several long-term marketplace health considerations justify this need:
1. Preliminary tests showed that an overwhelming majority of clicks and revenue on a SERP with a RAIS ad is derived from the RAIS ad. It is not in a long-term interest of the auctioneer/publisher to be vested in a single advertiser for a continued revenue stream.
2. Non-brand (text) advertisers might leave the marketplace if they lose a majority of their clicks.
3. Average Click quality of text advertisers might fall drastically if majority of their clicks are from relatively lower quality publishers where no RAIS ads are shown.
4. Accurate estimation of opportunity cost requires that text ads get a certain minimum impressions in any time period and finally.
5. Monitoring long-term performance RAIS where the text only SERP traffic is an ideal control set.

This need is met by defining a throttle-rate which is the minimum share of searches where no RAIS ads are shown. The throttle-rate may be set at 25% for competitive markets. For non-competitive markets with no other text ad (other than the RAIS advertiser), a RAIS ad may be shown whenever it meets quality and expected revenue requirements. It is noted, however, that the actual fraction of searches with text ads might be higher if the RAIS ads are of poor quality or low bids.

Ranking and placement of ads requires accurate estimation of the probability of click of each ad in a given context. One implementation of the sponsored search click prediction model estimates the probability of a click based on the historical click performance of the ad in various contexts. One of these contexts involves the position (north, east etc.) and rank of the ad. Given the dominant presence of RAIS on the SERP, for text ads appearing along with one RAIS ad in the north, the east ads get significantly fewer clicks relative to appearing alongside one text ad in the north. This information must be made available in the training data for the click prediction model so that what might initially seem like a much lower CTR is adequately accounted for when the broader context (RAIS presence in the north) is provided.

RAIS ads may be served on all Yahoo US traffic served from the SERP. This includes searches initiated from the universal search bar on Yahoo Owned and Operated properties but not those originating from site-specific searches conducted in a property search box. In one study, one month of data was used from all Yahoo US traffic for studying the RAIS marketplace. Further, a RAIS query set was defined comprising all the queries for which at least one RAIS ad was shown during the period under analysis. Data outside this query set was not considered for the purpose of this analysis.

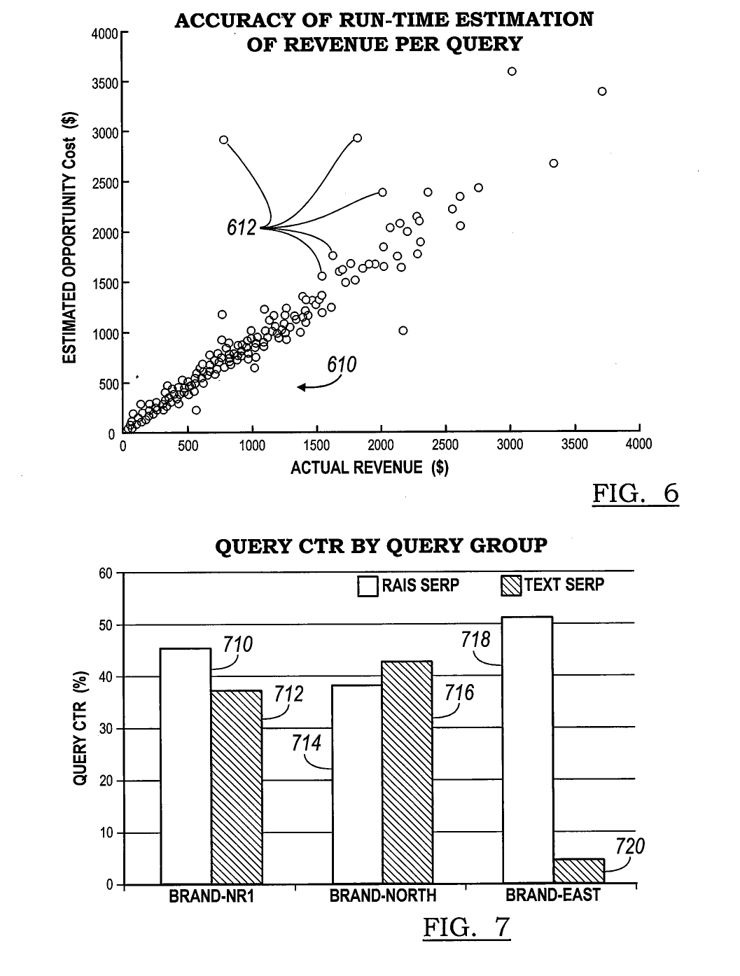

As stated earlier, the RAIS ad may be only shown when on average it brings at least as much revenue as the text ads that would have been shown without RAIS. This revenue is estimated by the expected revenue as described above. The characteristics of this estimate are analyzed below. First, to measure the reliability of this estimate, the actual revenue is computed for each query for a specific time period. For the same period, the average expected revenue per query was also computed. FIG. 6 shows the scatter plot indicating actual revenue with respect to the estimated revenue.

Now referring to FIG. 6, a graph of the estimated opportunity cost with respect to the actual revenue is plotted for a set of queries. Each query is represented by a dot 612. Further, the trend of the dots 610 generally indicates a linear relationship between the estimated opportunity costs and the actual revenue for each query.

The Pearson correlation coefficient is 0.95. The estimator bias is the ratio of total opportunity cost to the total revenue on the entire query set. In this case, this ratio was estimated to be 0.885 with a standard deviation of 0.21. Since the opportunity cost underestimates the actual revenue by about 12% overall, a scaling factor of 1.12 is incorporated into the RAIS premium factor, α.

Measuring incremental revenue requires comparing, on the RAIS query list, the SERPs that showed RAIS ads to those that did not. Throttling of RAIS ads ensures that there is sufficient data without RAIS ads to make this comparison reliably. Three standard sponsored search metrics were measured: a) Query click-through rate (qCTR), which is the ratio of the total number of clicks on all ads on the SERP to total number of SERP views with at least one ad; b) Query price per click (qPPC), which is the ratio of total revenue from all ads to the total number of clicks on all ads; and c) Query revenue per bidded search (qRPBS) which is the ratio of the total revenue from all ads to the total SERP views with at least one ad. Comparing the qCTR and qRPBS for SERPs with and without RAIS is the incremental RAIS clicks and revenue respectively.

There is a 55% gain in qCTR when a RAIS ad is shown and this translates into a 26% increase in revenue. The 55% gain in qCTR comes in spite of having replaced all the north ads by a single RAIS ad resulting in a significant decrease in pixels occupied by the sponsored listings. Since the advertiser pays the minimum necessary to maintain rank and position, the significantly higher qCTR results in a lower qPPC (−18%).

Although the above metrics do show that as a marketplace, RAIS ads bring in more revenue and drive more clicks, it is not sufficient to conclude that these additional clicks are due to the presence of the RAIS ad. This is because the above analysis does not control for the rank/page position (north/east/bottom) of the brand advertiser's text ad. Since these queries contain brand names, it is likely that the user will click on an ad from the brand advertiser, whether text or RAIS. It is also known that the CTR on ads in the north can be significantly higher than that in the east where user pays less attention. Therefore, the brand advertiser's text ad appearing in the east with the RAIS ad in the north is unlikely to get any clicks. This lowers the CTR for text SERPs and artificially inflates the gains from RAIS ad. Failing to control for these factors can cause one to misattribute qCTR increase to RAIS ads rather than the ad position.

In order to control for position of the brand advertiser's text ad, the RAIS queryset was partitioned into groups based on the dominant position of the brand advertiser's text ad. First, the (relative few) queries were removed when the brand advertiser does not bid on a text ad. The remaining queries are divided into 3 groups: a) Brand-NR1: brand advertiser appears in the rank 1 in the north b) Brand-North: brand advertiser appears in the north but not at rank 1 and c) Brand-East: brand advertiser appears in the east. One can conceivably have more granularity in defining groups (for example, brand advertiser in rank 1 in the north with no other north ad) but additional partitioning of data leads to sparsity issues and inaccurate estimates.

Now referring to FIG. 7, a bar graph for the click through rate is provided by each query group. Block 710 indicates the click through rate for a rich advertisement in group Brand-NR1. Block 712 indicates a text advertisement in group Brand-NR1. Block 714 represents a rich advertisement in group Brand-North, while block 716 represents a text advertisement in group Brand-North. Block 718 represents a rich advertisement in group Brand-East, while block 720 represents a text advertisement in group Brand-East.

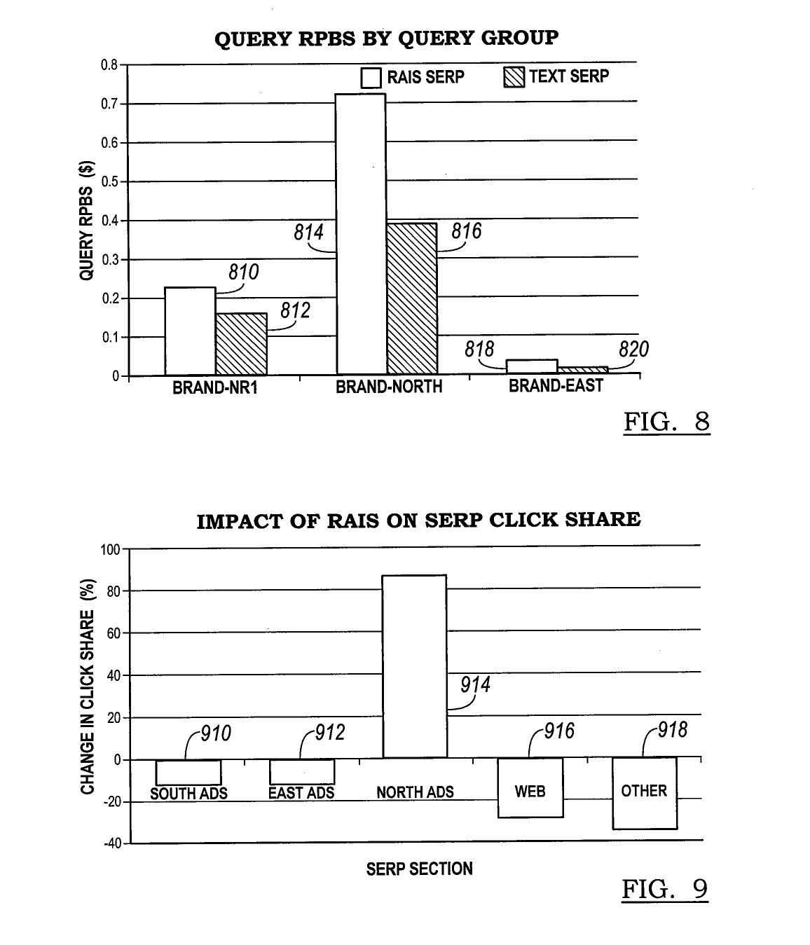

Now referring to FIG. 8, block 810 represents RPDS for a rich advertisement in group Brand-NR1, while block 812 represents a text advertisement in group Brand-NR1. Block 814 represents a rich advertisement in group Brand-North, while block 816 represents a text advertisement in group Brand-North. Finally, the block 818 represents a rich advertisement in group Brand-East, while the block 820 represents a text advertisement in group Brand-East.

FIGS. 7 and 8 show the qCTR and qRPBS for the three query groups for SERPs with and without a RAIS ad. Firstly, the significant variance in the qCTR gain across groups should be noted. The 22% increase in qCTR for Brand-NR1 is essentially the incremental clicks that the brand advertiser whose text ad already in rank 1 in the north gains from having a RAIS ad.

These gains come presumably from three factors, namely: the additional information in the RAIS ad, the visual appeal of the RAIS ad, and in part the north exclusivity. Secondly, the 14-fold increase in qCTR for Brand-East comes primarily from moving the brand advertiser from the east to the north. Other experiments have shown that about 70% of this qCTR increase is due to position/location of the ad with the remaining amount being attributable to the rich content in the ad. An interesting case, however, is the performance on the Brand-North query set where qCTR actually falls by 10%. One reason for this might be the displacement of relevant next ads to the east due to RAIS which can happen when the brand-resellers bid on queries in competitive markets. For example: one of the queries in this set is “2009 nissan versa” where there are eight ads in the east from dealers and review sites. The user, however, is less likely to notice these ads and might instead click on other parts of the page such as the web results.

Each listing appearing on the SERP impacts and the likelihood of a user clicking on other parts of the SERP. This is more significant in case of RAIS, given its prominent north position on the SERP. These results indicates that the total number of clicks on the SERP are 3% lower for SERPs with a RAIS ad. This implies that the RAIS ad does not generate new clicks but instead attracts clicks from other sections of the SERP. It is not clear whether this is undesirable, on one hand, this might imply that the RAIS ad helped the user achieve her goal with fewer clicks. On the other hand. it might also point to user dissatisfaction with the prominently placed but poor quality/irrelevant RAIS ad. Metrics such as dwell time, time to click or longitudinal tests might aid in the understanding of this phenomenon better.

FIG. 9 provides a bar graph illustrating the impact of a rich advertisement on an SERP click share. Block 910 represents the change in the click share of south ads due to the presence of a rich advertisement on the SERP. Likewise, block 912 shows how the rich advertisement in the north changes the click share of text advertisements in the east. Block 914 shows how the rich advertisement in the north changes the click share of text advertisements in the north. Block 916 shows how the rich advertisement in the north changes the click share of text advertisements in the web category, while block 918 shows how the rich advertisement in the north changes the click share of text advertisements in other positions on the SERP.

The share of clicks on the various sections of the SERP (SERP Click Share) was measured and the encountered changes when a RAIS ad is shown was observed. The SERP is divided into 5 broad sections: North Ads, East Ads, South Ads, Web results and “Other”. Majority of the clicks in “Other” are in shortcuts (images, videos, etc.), search assist and the search query box. FIG. 9 shows the change in the SERP click share of the 5 sections when a RAIS ad is present on the SERP. For this comparison, the entire RAIS query set was considered. It is clear that the RAIS ad gains click share while all other sections lose click share, most notably the web section and the shortcuts/search assist. By doing so, some RAIS advertisers are paying for clicks that they would have otherwise got from web results at no cost. This is particularly true on brand terms that are also typically navigational in nature where the RAIS brand advertiser's website might be ranked at the top of the web results. It is likely the advertisers derive significant value from RAIS ads since RAIS ads deny prominent north positions to competitors.

Several improvements within and beyond the current RAIS marketplace design are possible. Two extensions to this are being planned shortly: a) Competitive RAIS on non-brand terms: For terms like “car rental” several advertisers might want to compete for a single RAIS slot in the North. This however has challenging marketplace health implications if a single advertiser always wins the RAIS auction garnering a large majority of clicks. In such a scenario, relegating other advertisers to the east rail permanently might discourage advertisers from participating in RAIS auction thus driving down prices. This problem is not serious in some implementations since it is natural to expect the brand owner to get most of the clicks for brand queries. Yet in other variations RAIS may be dynamic. Here the advertiser submits a set of links, images, video etc. and the ad is dynamically composed and laid out at serve time based on user/query context.

New ad formats is a dynamic and growing area and several ad formats are being proposed and tested. New ad formats throw up interesting open problems. For instance, as the ad becomes richer, payment may be based on the user interaction with the ad—the advertiser might pay $0.50 for viewing the video but be willing to pay an extra $0.25 if the user visits the landing page. Some links in the ad might lead to landing pages with higher value for the advertiser and hence command a higher bid. Moreover, new ad formats with possibly differing payment mechanisms require accurate estimation of utility of the user, advertiser and the publisher. These utility estimates are a useful component of algorithms that optimize the overall SERP design by integrating individual modules such as web results (documents), images, videos, maps, sponsored listings, product listings etc.

The design of a sponsored search marketplace with RAIS ads—ads containing richer information such as additional links, videos and images has been presented herein. An extension of the GSP mechanism is provided to accommodate additional constraints in the placement of RAIS ads. Further, the performance of the RAIS marketplace on live-traffic has been analyzed for various keyword categories and the impact of RAIS ads on overall click pattern on the SERP. The successful integration of the RAIS marketplace with the existing text ad marketplace resulted in driving more clicks to advertisers and also generated 28% incremental revenue for Yahoo. Overall, these results show that there is significant potential for increased user engagement and revenue by augmenting additional information into the currently dominant plain text creatives.

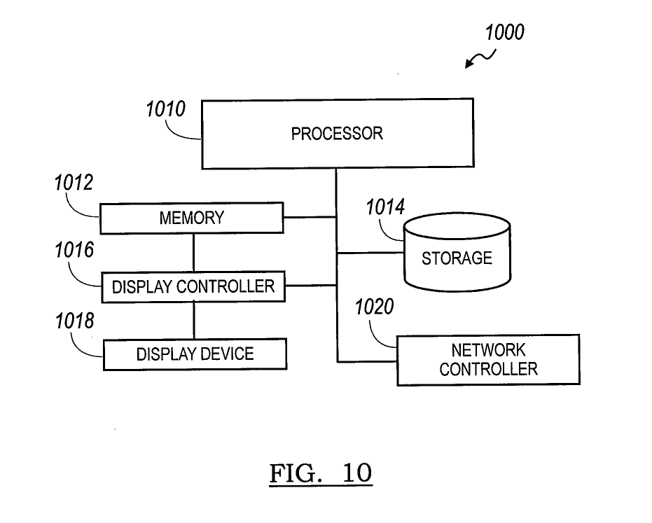

Any of the modules, servers, or engines described may be implemented in one or more computer systems. One exemplary system is provided in FIG. 10. The computer system 1000 includes a processor 1010 for executing instructions such as those described in the methods discussed above. The instructions may be stored in a computer readable medium such as memory 1012 or storage devices 1014, for example a disk drive, CD, or DVD. The computer may include a display controller 1016 responsive to instructions to generate a textual or graphical display on a display device 1018, for example a computer monitor. In addition, the processor 1010 may communicate with a network controller 1020 to communicate data or instructions to other systems, for example other general computer systems. The network controller 1020 may communicate over Ethernet or other known protocols to distribute processing or provide remote access to information over a variety of network topologies, including local area networks, wide area networks, the Internet, or other commonly used network topologies.

In another embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. A system for selecting a rich advertisement for display to a user, the system comprising:
an advertisement engine including a first selection module configured to select a list of text advertisements for a text slate based on a query entered by the user and determine an first expected revenue according to a first auction of text advertisements, the advertisement engine including a second selection module configured to select a rich advertisement for a mixed slate based on the query entered by the user, the second selection module determining a second expected revenue of the rich advertisement; and
wherein the advertisement engine determines whether to display the text slate or the mixed slate based on the first expected revenue of the slate of text advertisements and a the second expected revenue of the rich advertisement.

2. The system according to claim 1, wherein the second selection module determines the second expected revenue based on a second auction of rich advertisements.

3. The system according to claim 1, wherein the advertisement engine is only allowed to consider rich advertisements when the query includes a keyword in a predetermined whitelist.

4. The system according to claim 1, wherein only brand advertisers are allowed to bid on the rich advertisement when the query contains a brand.

5. The system according to claim 1, wherein the advertisement engine selects the rich advertisement only if the rich advertisement meets minimum quality and revenue requirements.

6. The system according to claim 1, wherein the advertisement engine places the rich advertisement in an exclusive north placement.

7. The system according to claim 6, wherein the advertisement engine removes text advertisements from the slate that correspond to the advertiser of the rich advertisement selected for display.

8. The system according to claim 7, wherein the slate of text advertisements are placed in a far east region.

9. The system according to claim 1, wherein the advertisement engine constrains the selection of the rich advertisement based on a throttle rate.

10. The system according to claim 1, wherein the advertisement engine computes a probability of click for each text advertisement in the slate using a click prediction model.

11. The system according to claim 1, wherein the first auction is a generalized second price auction.

12. The system according to claim 1, wherein a bid for the rich advertisement must exceed a predefined reserve price to be selected for display to the user.

13. The system according to claim 1, wherein a bid for the second expected revenue is determined based on the product of bid for the rich advertisement and a click through rate for the rich advertisement.

14. The system according to claim 1, wherein a price paid for the rich advertisement is determined based on a product of the bid for a second ranked rich advertisement and a ratio of the click through rate for the second ranked rich advertisement to a click through rate of the rich advertisement.

15. A method for selecting a rich advertisement for display to a user, the method comprising:
selecting a list of text advertisements for a text slate based on a query entered by the user;
determining a first expected revenue according to a first auction of text advertisements;
selecting a rich advertisement for a mixed slate based on the query entered by the user;
determining a second expected revenue of the rich advertisement; and
determining whether to display the text slate or the mixed slate based on the first expected revenue and a the second expected revenue of the rich advertisement.

16. The method according to claim 15, wherein the second expected revenue is determined based on a second auction of rich advertisements.

17. The method according to claim 15, further comprising placing the rich advertisement in an exclusive north placement, removing text advertisements from the slate that correspond to the advertiser of the rich advertisement selected for display, and placing the slate of text advertisements in a far east region.

18. In a computer readable storage medium having stored therein instructions executable by a programmed processor for selecting a rich advertisement for display to a user, the storage medium comprising instructions for:
selecting a list of text advertisements for a text slate based on a query entered by the user;
determining a first expected revenue according to a first auction of text advertisements;
selecting a rich advertisement for a mixed slate based on the query entered by the user;
determining a second expected revenue of the rich advertisement; and
determining whether to display the text slate or the mixed slate based on the first expected revenue and a the second expected revenue of the rich advertisement.

19. The computer readable storage medium according to claim 18, wherein the second expected revenue is determined based on a second auction of rich advertisements.

20. The computer readable storage medium according to claim 18, further comprising instructions for placing the rich advertisement in an exclusive north placement, removing text advertisements from the slate that correspond to the advertiser of the rich advertisement selected for display, and placing the slate of text advertisements in a far east region.
